(19) United States
(12) Patent Application Publication
(10) Pub. No.: US 2013/0137004 A1
(43) Pub. Date: May 30, 2013

(54) Device for Humidifying Anode Gas

(71) Applicants: Steffen Dehn, Nersingen (DE); Martin Quintus, Goeppingen (DE); Felix Sterk, Schlier (DE)

(72) Inventors: Steffen Dehn, Nersingen (DE); Martin Quintus, Goeppingen (DE); Felix Sterk, Schlier (DE)

(73) Assignee: Daimier AG, Stuttgart (DE)

(21) Appl. No.: 13/704,544

(22) PCT Filed: May 14, 2011
(86) PCT No.: PCT/EP2011/002401

§ 371 Date: Jan. 14, 2013

(30) Foreign Application Priority Data
Jun. 17, 2010 (DE) 1020100241873

(51) Int. Cl. H01M 8/06

(52) U.S. Cl. CPC H01M 8/0662
USPC 429/414

(57) ABSTRACT

A device for moistening an anode chamber of a fuel cell and/or a gas flow to the anode chamber of the fuel cell includes a water separator in an exhaust gas flow from the anode chamber and a moistening device for supplying at least a part of the water to the anode chamber and/or to the gas flow flowing to the anode chamber. The water separator and the moistening device are connected via a line element. The water separator is pressurized so that the pressure in the region of the water separator can be increased at least temporarily over the pressure in the region of the moistening device. The pressurization takes place by means of a gas, whereby a valve is arranged in the gas flow flowing to the anode chamber.

### BACKGROUND AND SUMMARY OF THE INVENTION

Exemplary embodiments of the present invention relate to a device for moistening an anode chamber of a fuel cell and/or a gas flow flowing to the anode chamber of the fuel cell.

A fuel cell or a stack of individual fuel cells, a so-called fuel cell stack, is typically operated with hydrogen on the anode side and oxygen or air on the cathode side. The hydrogen flowing to the anode side is typically hydrogen from a compressed gas storage element. It flows via a valve means for pressure reduction in most cases without being moistened into the region of the anode. The anode chamber of the fuel cell is very frequently operated with moistened air as an oxygen provider. This is meaningful and necessary since in the case of a PEM fuel cell, which constitutes one of the most frequently used types of fuel cells, in particular for motor vehicle applications, a certain moistening of the polymer membranes is necessary in order to maintain the functionality of the cell. Generally, the moistening of the air for the cathode side of the fuel cell is comparatively simple to realize and is sufficient in most cases to ensure an at least basic moistening.

On the other hand the hydrogen is typically fed dry from the compressed gas storage element of the fuel cell. This is particularly problematic for the first single cell in the fuel cell stack or, in case of a fuel cell stack constructed in a cascade, for the first row of single cells, as these are not moistened on the anode side. This results in a poorer proton conductivity of the membranes in the region of this cell or this row of single cells and thus leads to a poorer level of electrical efficiency.

German Patent Document DE 101 10 419 A1 and United States Patent Document US 2001/021468 A1 describe a fuel cell system with moistening elements on both the anode side and on the cathode side. Each element provides that, by means of membranes which are permeable to water vapor, the exhaust gas flow of the anode or the cathode correspondingly moistens the respective supply flow of gas, thus air or oxygen. A water separator is also provided that separates water remaining after flow-through of the membrane moistening element, from the respective exhaust gases in liquid form. This water is then collected and fed via a pump and a non-return valve back to the region of the gas flowing to the anode chamber or cathode chamber and fed in the region of this gas after this has flowed through the membrane element for moistening, for example being injected.

The structure with the plurality of moistening means in the form of the membrane element and a moistening of water collected via a water separator requires correspondingly great resources and is thus very expensive. It also requires a comparatively large construction space, in particular in the region of the anode, which has the significant disadvantage that comparatively great flow lengths arise in line elements, components and similar. Since sealing for the hydrogen flowing inside requires comparatively high resources and diffusion losses are practically unavoidable, this constitutes a certain disadvantage in relation to the hydrogen consumption to be expected.

In addition a water pump is always necessary in the region of the collecting container of the water separator so that a parasitic power requirement is produced, which correspondingly impairs the overall degree of efficiency of the fuel cell system. The extent to which this can be compensated by an improvement in the moistening of the first cell or the first row of cells of the fuel cell system is questionable according to the calculations and investigations carried out at least on the side of the anode chamber of the fuel cell.

United States Patent Document US 2007/048572 A1 describes a concept for the cathode side, wherein a recirculation of water is achieved via pressure differences.

Exemplary embodiments of the present invention provide a device for moistening an anode chamber of a fuel cell and/or a gas flow flowing to the anode chamber of the fuel cell, which facilitates a very simple, compact and energy-efficient structure.

The structure according to the invention provides a backflow prevention means disposed between the anode chamber and the water separator, through which backflow prevention means there can be a flow in the direction of the water separator. In addition a means for pressurization of the water separator by means of a gas is provided, through which the pressure can be increased in the region of the water separator at least temporarily over the pressure in the region of the moistening means. The structure thus provides that, instead of a water collecting container with a pump between the water separator and the anode chamber, a non-return valve or similar is incorporated so that there can only be a flow through this section in the direction of the water separator. Suitable means can then be used to subject the water separator to a pressure that, at least temporarily during the operation of the fuel cell, is above the pressure in the region of the moistening means. By means of the higher pressure in the region of the water separator the water collected therein can be fed to the moistening means and, from here, can moisten either the anode chamber directly and/or the gas flow flowing to the anode chamber. According to the invention the pressurization takes place by means of a gas. Since gases are typically present at different pressure levels in the region of a fuel cell system the gas can originate in particular from a region in which it has the necessary/required pressure anyway so that the additional power for conveying the gas during operation of the fuel cell system is not required at all. In order to facilitate a suitable pressure influence a valve means is arranged in the gas flow flowing to the anode chamber.

According to a particularly favorable and advantageous development of the device according to the invention the gas comprises hydrogen. The gas, with which the water separator is impacted with pressure, can thus comprise hydrogen or can be hydrogen. As the hydrogen is present anyway in the region of a compressed gas storage element at a very high pressure level, this can be used ideally to also subject the water separator to pressure and to carry out a recirculation of the separated water into the region of the anode or into the region of the gas flow flowing to the anode. Since hydrogen is typically also the gas with which the anode chamber of the fuel cell is supplied, it is non-critical and not disadvantageous for the operation of the fuel cell if the gas flows through the pressurization into the region of the anode chamber, as this gas, if it is hydrogen or comprises hydrogen, can contribute to the fuel supply of the fuel cell.

According to a further particularly favorable and advantageous embodiment of the device according to the invention the gas is the exhaust gas flow from the anode chamber. In particular, with an open-end fuel cell, for example in a cascade construction, a certain residual amount of hydrogen leaves the region of the anode chamber together with the water. This is either lost or is fed, for example, for post-combustion in order to recover thermal energy and not to allow any hydrogen emissions to the environment. This gas from the exhaust gas flow of the anode chamber is thereby extremely suitable in its composition to carry out the pressurization of the water separator and to flow together with the water back into the region of the gas flowing to the anode chamber and/or into the anode chamber itself.

According to a very advantageous further development of the device according to the invention the pressurization takes place through an operation of the fuel cell that is dynamic at least with regard to the operating pressure. Fuel cells, in particular fuel cells that are used for providing drive energy in vehicles, are typically not stationary but instead are operated between dynamically and highly dynamically corresponding to the power requirements of the vehicle. Such a highly dynamic operating mode of the fuel cell system is expressed not only in the removal of electrical power with a highly dynamic profile, but also results in a highly dynamic operating mode of the working pressure or at least facilitates this. The pressurization of the water separator can take place in a particularly simple and efficient manner through a dynamic operation in relation to the working pressure, which is either designed specifically for the realization of the moistening with the device according to the invention or is adjusted in any case on the basis of the dynamic operation of the fuel cell. If there is a pressure increase in the region of the fuel cell the water will correspondingly collect in the region of the water separator and, due to the higher pressure in the region of the gas flowing to the anode chamber, will not flow away into the region of this gas or the anode chamber. If there is a pressure reduction in the supply of the fuel cell with the gas flowing to the anode chamber, the pressure in the region of the water separator will be higher than the pressure in the gas flowing to the anode chamber at least for a short time period. In these operating situations the water will then be removed via the moistening means into the anode chamber or into the gas flowing to the anode chamber and thus moisten said anode chamber or said gas.

According to a particularly favorable and advantageous development of the device according to the invention a backflow prevention means is disposed between the water separator and the moistening means, through which there can be a flow in the direction towards the moistening means. This ensures that no pressurization of the water separator takes place through the gas flowing to the anode chamber.

According to a particularly favorable and advantageous further development of the device according to the invention a means is further provided in the region of the moistening means for atomization and/or evaporation of the water. Through such means for atomization and/or evaporation an aerosol or a water vapor can be produced that achieves the moistening of the anode chamber and/or the gas flow flowing to the anode chamber in such a manner that there is adequate moistening without too much liquid water “flooding” sub-regions of the anode chamber and the contact of parts of the membrane with the gas being prevented through liquid water.

According to an advantageous further development at least one membrane permeable to water vapor is disposed in the region of the moistening means which is in contact on one of its sides with the water and on its other side with the gas flowing to the anode chamber. The structure according to the invention also allows here the use of a membrane, which is particularly advantageous if the gas with which the water separator is pressurized is not hydrogen or a hydrogen-containing gas. For example, in case of pressurization with exhaust gas from the cathode region with oxygen or nitrogen, this constitutes a significant advantage as through the membranes merely the water vapor reaches the region of the gas flowing to the anode chamber and a mixing of the gases themselves cannot arise.

According to a further very favorable and advantageous embodiment the moistening means comprise nozzle means for introducing water into the anode chamber and/or into the gas flow flowing to the anode chamber. This particularly simple structure atomizes the water to form a fine aerosol, in particular using the gas used for pressurization. This facilitates a very simple and efficient moistening, whereby through the finely distributed water droplets during atomization a flooding of the anode chamber through larger amounts of liquid water can also be securely and reliably prevented. The structure is thereby extraordinarily efficient, as a comparatively large amount of water can be atomized in a very energy-efficient manner in the anode chamber and/or in the gas flow flowing to the anode chamber.

According to a further very advantageous embodiment of the device according to the invention the moistening means and/or the anode chamber comprise(s) a surface region for improved transition of the water into the gas flow flowing to the anode chamber or flowing in the anode chamber. Such a surface can be formed, for example, by appropriately enlarging the surface via corresponding roughness, a suitable material or similar so that the transition of the water into the gas flow flowing to the anode chamber and or into the gas already in the anode chamber is correspondingly facilitated.

According to a particularly favorable and advantageous development this surface region is heated. Besides the transition, for example, through a rough surface on which corresponding swirling of the gas flow arises so that the water can be taken up and carried along more easily, a heating of the surface region can also be provided, so that alternatively or additionally to the purely mechanical taking up of the water into the gas flow, a heating of the water as far as the point of evaporation can take place. The take-up of the water by the gas is thus further improved.

### BRIEF DESCRIPTION OF THE DRAWING FIGURES

Further advantageous embodiments of the device according to the invention thereby follow and will become clear using an exemplary embodiment which is explained in greater detail below by reference to the drawings in which:

FIG. 1 shows a first possible embodiment of the device according to the invention;

FIG. 2 shows a second possible embodiment of the device according to the invention;

FIG. 3 shows a first embodiment of the moistening means in the device according to the invention; and

FIG. 4 shows a second embodiment of the moistening means in the device according to the invention.

### DETAILED DESCRIPTION

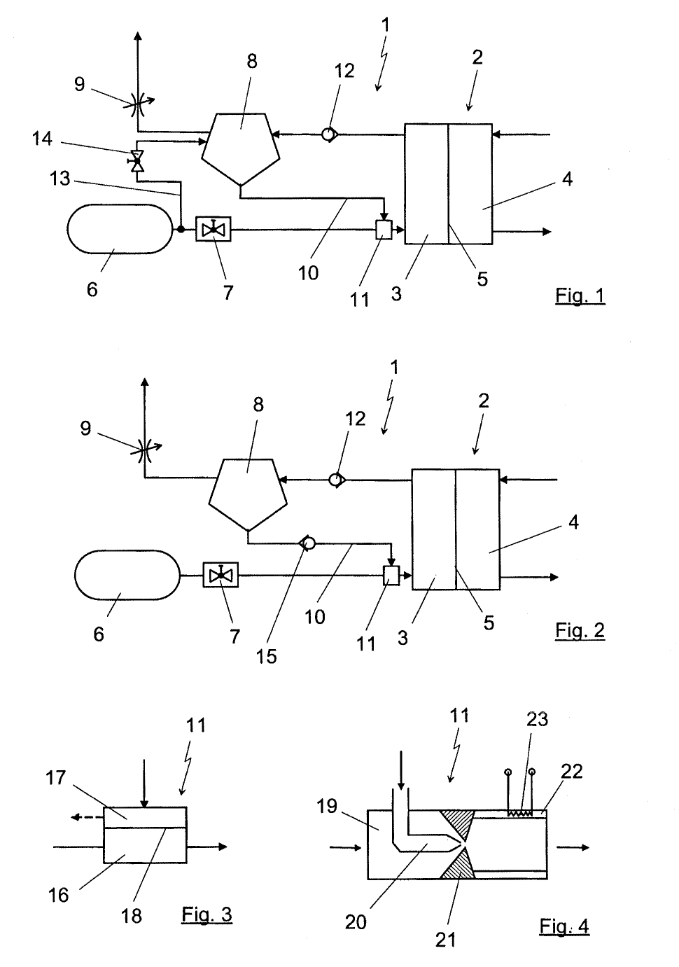

FIG. 1 illustrates a cut-out from a fuel cell system 1. The illustrated fuel cell 2 can be configured as a so-called PEM fuel cell and is typically constructed as a stack of individual cells. Each of the individual cells comprises an anode chamber 3 and a cathode chamber 4, which are indicated by way of example in the exemplary embodiment shown here. The anode chamber 3 and cathode chamber 4 are separated from each other via a proton-conducting membrane (PE membrane) 5. Air as an oxygen provider is fed to the cathode chamber 4 in the known way and an exhaust air flow depleted of oxygen thus flows out of the cathode region 4. This is known from the general prior art in such a way that this will not be described in greater detail within the scope of the structure described here.

The anode chamber 3 of the fuel cell 2 is supplied with hydrogen from a compressed gas storage element 6 via a valve means 7 for pressure reduction. The compressed gas storage element 6 thereby works typically at pressure levels of 350 or 700 bar and supplies the anode chamber 3 of the fuel cell 2 with hydrogen with a comparatively high level of purity. The hydrogen from the compressed gas storage element 6 is thereby comparatively dry after the valve means 7 so that, in spite of the typically moistened supply air flow to the cathode chamber 4 of the fuel cell 2, a drying at least of the first cells or rows of cells of the fuel cell 2 can arise in the region of its anode chamber 3. When using a fuel cell 2 that is operated without a so-called anode loop, thus which is either formed as a dead-end fuel cell 2 from which no further gas escapes but in which all the hydrogen is taken up in the anode chamber 3, or as a so-called open-end fuel cell 3 in which a certain amount of residual hydrogen leaves the anode region 3, this moistening of the first cell or, in case of the construction of the anode chamber 3 in a cascade form, the first row of cells constitutes a significant challenge.

The structure in FIG. 1 thereby shows the structure of the fuel cell 2 as an open-end fuel cell, in which an exhaust gas flow from the anode chamber 3 is carried away via a water separator 8 and a throttle valve 9. This residual hydrogen then reaches either the environment or can be subsequently combusted in a burner, for example a catalytic burner, a pore burner or similar, in order to use its thermal energy content. The water separator 8 in the region of the exhaust gas flow from the anode chamber 3 is thereby also designed in the known way and serves for the separation of liquid water droplets in the region of the exhaust gas flow. This liquid water collects in the lower region of the water separator 8 and passes via a line element 10 into the region of a moistening means 11 in order to be fed either directly to the anode chamber 3 and/or to the gas flow flowing to the anode chamber in order to moisten it. A backflow prevention means 12 is provided in the region between the anode chamber 3 and the water separator 8. The exhaust gas flow from the anode chamber 3 can flow through this backflow prevention means 12 merely in the direction towards the water separator 8.

In order to achieve moistening of the gas flow flowing to the anode chamber in the region of the moistening means 11 without having to apply additional energy, for example through a pump or similar, the water separator 8 can be impacted via a line element 13 with a valve means 14 with hydrogen under pressure from the compressed gas storage element 6 which is branched off in the region of the valve means 7 or in the region before the valve means 7. The backflow prevention means 12 then prevents the hydrogen under pressure flowing “from behind” into the anode chamber 3 of the fuel cell 2. By means of a suitable adjustment of the throttle valve 9, a notable amount of hydrogen can be prevented from flowing away out of the fuel cell system 1. The hydrogen under pressure in the water separator 8 will then convey, via the line element 10, the water and at least a part of the hydrogen into the region of the moistening means 11, in the region of which this water serves for moistening the anode chamber 3 and/or the gas flow flowing to the anode chamber 3. The structure is thereby particularly simple and efficient and manages merely with an additional line element 13 and the additional valve means 14 without requiring a conveying means or similar, which would require power during the operation of the fuel cell system 1.

FIG. 2 shows a further, even more simplified structure of the fuel cell system 1, in which a comparable functionality can be realized. The line element 13 and the valve means 14 have been omitted in the structure of the fuel cell system 1 shown in FIG. 2. In the region of the line element 10 a further backflow prevention means 15 is thereby provided, through which there can be a flow merely in the direction from the water separator 8 to the moistening means 11. The functionality is otherwise the same, whereby the conveyance of the water from the water separator 8 into the region of the moistening means 11 takes place here in a dynamic operation of the fuel cell system 1. According to a first operating state the pressure of the gas flowing to the anode chamber 3 is thereby comparatively high. In this situation the backflow prevention means efficiently prevents a penetration of this gas into the region of the water separator 8. The exhaust gas flow from the anode chamber 3 passes via the backflow prevention means 12 into the region of the water separator. Liquid water can hereby be separated and any residual gases can be carried away continuously or from time-to-time via the throttle valve. If, due to the dynamic operation of the fuel cell 2, the pressure in the region of the gas flowing to the anode chamber 3 falls, a pressure difference forms between the water separator 8 and the anode chamber 3. In these situations the backflow prevention means 12 closes so that the exhaust gas flow from the region of the water separator 8 cannot flow back into the anode chamber 3. At the same time the backflow prevention means 15 opens and thus allows the flowing away of the water which has collected in the region of the water separator 8 via the line element 10 into the moistening means 11. By means of the moistening means 11 a moistening of the anode chamber 3 and/or the gas flow flowing to the anode chamber 3 can be achieved with the water from the water separator 8. As the operation of a fuel cell 2, in particular if this is used for the production of electrical drive power in a vehicle, typically takes place dynamically or highly dynamically, an adequate moistening of the anode chamber 3 or the gas flow flowing to the anode chamber 3 can be ensured in an average time over the operating duration of the fuel cell, in particular as a drying of the moistened membrane of the first cell or the first row of cells requires a certain time so that at least on statistical average before the membranes are dried, a renewed operating phase with pressure conditions that allow a re-moistening of the anode chamber 3 and/or the gas flow flowing to the anode chamber 3 arises.

In the illustration of FIG. 3 a first possible embodiment of the moistening means 11 is shown by way of example. This moistening means 11 consists of a first sub-region 16, through which a gas flow flowing to the anode chamber 3 flows. A second sub-region 17 is separated from the sub-region 16 through a membrane permeable to hydrogen. In the region of the sub-region 17 the water from the water separator 8 is thus present and can for example be evaporated or atomized in this sub-region 17. Hydrogen arising can pass through the membrane 18 into the sub-region 16 and thus moisten the gas flowing to the anode chamber. Remains can, as indicated, flow away if necessary. This structure is particularly advantageous when a gas is used for pressurizing the water separator 8, where the gas is not to reach the region of the anode chamber, thus for example oxygen, nitrogen or similar inert gas.

In the illustration of FIG. 4, an alternative embodiment of the moistening means 11 can be seen. The moistening means 11 thereby comprises a single chamber 19, through which the gas flow flowing to the anode chamber 3 flows. In addition a nozzle 20 is provided, through which the water passes from the water separator 8 to the region of the moistening means 11. Through an appropriate selection of the nozzle form and possibly a diaphragm 21, atomization of the water can be achieved in the region of the gas flow flowing to the anode chamber 3 solely through the pressure of the pressurization of the water separator 8 and an under-pressure of the passing gas forming through the diaphragm 21 and the nozzle 20 can be achieved. This structure is particularly suitable when the gas used for pressurization of the water separator 8 is hydrogen or at least contains hydrogen because in addition to atomization of the water, the gas typically used for pressurization reaches the gas flow flowing to the anode chamber. This hydrogen can then be passed in the region of the anode chamber 3 into the fuel cell as intended.

In both structures of the moistening means 11 and other structures of moistening means 11 known from the general prior art it can further be provided that suitable surfaces 22, for example with a corresponding surface roughness or similar, are arranged in the region of the moistening means 11 or in the region of the anode chamber 3 itself, which facilitate the take-up of water collecting in this region of these surfaces through the gas flow flowing over the surfaces of the gas flowing to the anode chamber 3 or already present in the anode chamber 3 and also flowing here. Such surfaces 22, which are shown by way of example in FIG. 4, could, for example, comprise suitable degrees of surface roughness or materials in order to achieve such an effect. In particular these surfaces 22 could also comprise heating, for example electric heating, as indicated in FIG. 4 through a heating coil 23, which is schematically illustrated. Such a structure can, alternatively or additionally to an improvement of the mechanical transition of the water into the gas flow through the heating, achieve a heating or evaporation of the water so that this can be taken up by the gas flow flowing past in a further improved way.

All in all, the fuel cell system according to the structures described here constitutes a very simple, efficient, compactly constructed and energy-optimized variant for moistening of an anode chamber 3 of the fuel cell 2 or the gas flowing to the anode chamber 3 of the fuel cell 2. In particular the first cell, or in case of a cascade fuel cell stack 2, the first row of cells is thus adequately moistened so that the electrical performance of the fuel cell 2 can be improved in all operating situations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A device for moistening an anode chamber of a fuel cell or a gas flow flowing to the anode chamber of the fuel cell with water, the device comprising:
a water separator arranged in an exhaust gas flow from the anode chamber;
a moistening device configured to supply at least a part of the water to the anode chamber or the gas flow flowing to the anode chamber, wherein the water separator and the moistening device are connected via a line element;
a backflow preventer configured between the anode chamber and the water separator, and configured to allow a flow in a direction of the water separator; and
a valve configured in the gas flow flowing to the anode chamber, wherein the valve is configured to pressurize the water separator by means of a gas so that a pressure in a region of the water separator is at least temporarily increasable above a pressure in a region of the moistening device.

12. The device according to claim 11, wherein the gas comprises hydrogen.

13. The device according to claim 11, wherein the gas is the exhaust gas flow from the anode chamber.

14. The device according to claim 11, wherein the gas originates from a compressed gas storage element.

15. The device according to claim 11, wherein the pressurization takes place through an operation of the fuel cell which is dynamic at least in relation to an operating pressure, for which purpose another backflow preventer is disposed between the water separator and moistening device, the another backflow preventer is configured to allow a flow in a direction of the moistening device.

16. The device according to claim 11, further comprising:
a throttle valve configured to remove gas from the water separator.

17. The device according to claim 11, further comprising:
an atomizer or evaporator configured in a region of the moistening device.

18. The device according to claim 17, further comprising:
at least one membrane permeable to water vapor, which is arranged in a region of the moistening device, a first side of the membrane is in contact with the water and a second side of the membrane is in contact with the gas flowing to the anode chamber.

19. The device according to claim 18, wherein the moistening device comprises a nozzle configured to inject the water into the anode chamber or into the gas flow flowing to the anode chamber.

20. The device according to claim 19, wherein the moistening device or the anode chamber comprises a surface region configured to facilitate transition of the water into the gas flow flowing to the anode chamber.

21. The device according to claim 20, wherein the surface region is heated.
